(19) United States
(12) Patent Application Publication
(10) Pub. No.: US 2010/0027066 A1
(43) Pub. Date: Feb. 4, 2010

(54) DISPLAY-INTEGRATED IMAGE FORMING APPARATUS

(76) Inventors: Yasuhiro NAKAI, Osaka-shi (JP); Satoshi Machino, Osaka-shi (JP); Osamu Ueda, Osaka-shi (JP)

Correspondence Address: BIRCH STEWART KOLASCH & BIRCH, PO BOX 747, FALLS CHURCH, VA, 22040-0747, US

(21) Appl. No.: 12/511,592

(22) Filed: Jul. 29, 2009

(30) Foreign Application Priority Data
Jul. 30, 2008 (JP) 2008-195765

(51) Int. Cl. G06F 15/00

(52) U.S. Cl. 358/1.15

(57) ABSTRACT

A display-integrated image forming apparatus is provided that requires no large disposition location and an extremely simple disposition operation and that is capable of acquiring sufficient advertising effects for pedestrians on sidewalks.

The display-integrated image forming apparatus comprises an image forming device including a document reading portion and a printing portion and a displaying device including a first display screen viewable from the backside or the side of the image forming device. When a user selects arbitrary information from provision information displayed on the first display screen, the first display screen displays information related to printing such as a password. By operating the image forming device to input the password the user visually recognizing the information is able to print out information preliminarily correlated with the selected provision information.

### CROSS-NOTING PARAGRAPH

This non-provisional application claims priority under 35 U.S.C. §119(a) on Patent Application No. 2008-195765 filed in JAPAN on Jul. 30, 2008, the entire contents of which are hereby incorporated herein by reference.

### FIELD OF THE INVENTION

The present invention relates to a display-integrated image forming apparatus and more specifically to a display-integrated image forming apparatus combining an image forming device such as a multi-function peripheral or a digital copy machine with a large-sized displaying device.

### BACKGROUND OF THE INVENTION

Recently, image forming apparatuses such as multi-function peripherals or digital copy machine are disposed in a multiplicity of mass sales stores including convenience stores and supermarkets and mainly used when users utilizing the stores make copies of documents.

A recent convenience store has a fully glass-walled store portion facing the road (sidewalk) and merchandises are displayed such that pedestrians walking on the sidewalk can see at a glance how the inside of the store are. For example, a disposition pattern shown in FIG. 22 is common, in particular a bookshelf 510 is disposed along a glass window 501 on the larger-space side, an image forming apparatus A is disposed along a glass window 502 on the smaller-space side across an entrance 500 and a checkout counter not shown in the figure is disposed inside the store behind the image forming apparatus A. In such a disposition format, conventionally, paper advertisements such as posters 505 are directly affixed on the glass windows 501 and 502 facing the sidewalk toward the outside of the store to perform promotional activities for pedestrians. Paper advertisements are also stuck on small spaces in display racks in the store to perform promotional activities for customers in the store.

In such a promotional activity, it is difficult to frequently switch the advertisements and it is problematic that a detailed promotional activity may not be performed depending on time zones in such a way that a promotional activity targeting office workers is performed in a time zone when office workers mainly pass through and that a promotional activity targeting housewives and students are performed in a daytime when housewives and students mainly pass through, for example.

The technique of using fully glass-paned walls facing sidewalks and affixing advertisements on glass surfaces is also employed by real-estate companies, etc., to affix and provide paper advertisement of various pieces of real-estate information all over the surface of the glass wall for pedestrians. However, in this case, since employees must manually remove real-estate information of concluded agreements of rental and sale and affix new real-estate information, the removal and affixing are frequently forgotten and it is problematic that the provision information may not necessarily be the latest information.

On the other hand, as described above, the image forming apparatuses disposed in the stores are only used when users utilizing the stores make copies of documents and are rarely utilized for other purposes in the present circumstances. Therefore, arrangements are conventionally devised so as to improve the usage efficiencies of such image forming apparatuses (see e.g., Japanese Patent Application Laid-Open Publication Nos. 2002-329139, 2002-156873, and 2002-55501).

Japanese Laid-Open Patent Publication No. 2002-329139 describes an advertisement information processing system having a wall display and a printer connected and disposed in a store and capable of printing advertisement information with the printer at the time of pushing of a print button corresponding to the advertisement information displayed on the wall display.

Japanese Laid-Open Patent Publication No. 2002-156873 describes an image processing apparatus being a copy machine and connected with a cash register over LAN and reading a notice image document set on a document platform of the copying machine to display this notice image on an operation screen of the copy machine and on a displaying device of the cash register through the LAN.

Japanese Laid-Open Patent Publication No. 2002-55501 describes an image forming device having a liquid crystal monitor attached to a front cover or a side cover of the main body of the image forming device and displaying output signals of a personal computer on a displaying portion of the liquid crystal monitor.

As above, arrangements of enhancing the advertisement/promotion function with the use of an image forming apparatus are conventionally implemented by connecting the image forming apparatus with a displaying device to print advertisement information displayed on the displaying device with the image forming apparatus or to display a notice image read by the image forming apparatus on an operation screen of the image forming apparatus or a displaying device of a cash register.

However, in the case of Japanese Laid-Open Patent Publication No. 2002-329139, since a display must be disposed on the entire wall surface facing the sidewalk and this display must be connected to a printer disposed in-store through a communication cable, a large-scale disposition operation is necessary, and since the disposition must be performed for each store, it is problematic that the disposition operation is extremely troublesome. Once disposed, it is also problematic that a layout may not easily be changed even if it is desired to change a layout on a case-by-case basis.

In the case of Japanese Laid-Open Patent Publication No. 2002-329139, the advertisement information is printed out when the print button for the displayed advertisement information is pushed and the advertisement information may unnecessarily be printed out when the print button is needlessly pushed by a person who does not want the advertisement.

In the case of Japanese Laid-Open Patent Publication No. 2002-156873, although the advertisement information may be displayed on the operation screen of the information forming apparatus or the display screen of the cash register, this is advertisement/promotion for customers in the store and does not act as advertisement/promotion for pedestrians walking on the sidewalk in front of the store. It is problematic that the customers in the store hardly notice the advertisement information if the advertisement information is only displayed on the operation screen of the image forming apparatus or the display screen of the cash register and the advertising effect may not sufficiently be acquired.

In the case of Japanese Laid-Open Patent Publication No. 2002-55501, although the advertisement information may be displayed on the display screen of the liquid crystal monitor, this is the display for the operator of the image forming apparatus and does not acts as advertisement/promotion for pedestrians walking on the sidewalk in front of the store. Although it is conceivable that the advertisement/promotion for customers in the store is performed by displaying the advertisement information on the liquid crystal monitor, it is problematic that the customers in the store hardly notice the advertisement information if the advertisement information is displayed on a display screen of such a small liquid crystal monitor and the advertising effect may not sufficiently be acquired.

In the case of Japanese Patent Application Laid-Open Publication Nos. 2002-329139 and 2002-156873, data such as advertisement information is directly stored in the apparatus disposed in the store, etc., and more storage capacity is needed as the data increases.

Although an image forming apparatus and a large-screen (e.g., 50-inch) displaying device are disposed and connected through a cable in some cases, how to ensure a wider selling floor space is an issue in stores such as convenience stores and supermarkets, and the two large-sized devices are not commonly arranged side-by-side as above since the selling floor space is reduced. Since even the disposition locations may not be ensured in the case of small stores, this system is not necessarily advantageous to the stores in the present circumstances.

For example, the 52V-inch liquid crystal display (PN-525 manufactured by Sharp Corporation) has the external dimensions of 1254 mm height×742 mm width×92 mm depth and a weight of 44 kg; the liquid crystal display stand (ID-DS03W manufactured by Sharp Corporation) has the external dimensions of 917 mm width×870 mm depth; and the digital multi-function peripheral (MX-3500FN manufactured by Sharp Corporation) has the external dimensions of 950 mm height×645 mm width×670 mm depth and a weight of 120 kg. When the liquid crystal display and the digital multi-function peripheral are serially arranged, a necessary footprint is defined by width: 917 mm of the liquid crystal display stand width×depth: 1540 mm (670 mm depth of the digital multi-function peripheral+870 mm depth of the liquid crystal display stand).

### SUMMARY OF THE INVENTION

It is the object of the present invention to provide a display-integrated image forming apparatus requiring no large disposition location and an extremely simple disposition operation and capable of acquiring sufficient advertising effects for pedestrians on sidewalks.

Another object of the present invention is to provide a display-integrated image forming apparatus comprising: an image forming device including a document reading portion that reads an image of an document, a first operating portion that accepts operational input, a printing portion that performs a printing operation in accordance with an operation to the first operating portion, and a control portion that controls the above portions; and a displaying device being disposed on at least one side surface of the image forming device, the displaying device including a first display screen viewable from the backside or the side of the image forming device, the display-integrated image forming apparatus displaying various pieces of provision information to be provided to users on the first display screen through the control portion of the image forming device, the display-integrated image forming apparatus comprising a second operating portion that accepts operational input to the first display screen, the display-integrated image forming apparatus displaying information related to printing of selected provision information on the first display screen if the provision information displayed on the first display screen is selected through an operation to the second operating portion.

Another object of the present invention is to provide the display-integrated image forming apparatus, wherein the image forming device includes a storage portion that stores information, and wherein the control portion stores the information related to printing of the selected provision information into the storage portion.

Another object of the present invention is to provide the display-integrated image forming apparatus, wherein if the information related to printing of the provision information displayed on the first display screen is input to the first operating portion, the printing portion prints information preliminarily correlated with the selected provision information.

Another object of the present invention is to provide the display-integrated image forming apparatus, wherein if the information related to printing of the provision information displayed on the first display screen is input to the first operating portion, the control portion clears the information related to printing of the provision information displayed on the first display screen.

Another object of the present invention is to provide the display-integrated image forming apparatus, wherein if a predetermine time elapses without the information related to printing of the provision information being input to the first operating portion after the information related to printing of the provision information is displayed on the first display screen, the control portion clears the information related to printing of the provision information displayed on the first display screen.

Another object of the present invention is to provide the display-integrated image forming apparatus, wherein if a predetermine time elapses without the information related to printing of the provision information displayed on the first display screen being input to the first operating portion after the information related to printing of the provision information displayed on the first display screen is cleared, the information related to printing of the provision information displayed on the first display screen is cleared from the storage portion.

Another object of the present invention is to provide the display-integrated image forming apparatus, comprising a second display screen viewable from an operator of the image forming device, wherein the second display screen is disposed to project upward from the image forming device.

Another object of the present invention is to provide the display-integrated image forming apparatus, comprising a third operating portion that accepts operational input to the second display screen, wherein if the information related to printing of the provision information displayed on the first display screen is input to either the first operating portion or the third operating portion, the printing portion prints information preliminarily correlated with the selected provision information.

Another object of the present invention is to provide the display-integrated image forming apparatus, wherein if the information related to printing of the provision information displayed on the first display screen is input to either the first operating portion or the third operating portion, the control portion clears the information related to printing of the provision information displayed on the first display screen.

Another object of the present invention is to provide the display-integrated image forming apparatus, wherein if a predetermine time elapses without the information related to printing of the provision information displayed on the first display screen being input to either the first operating portion or the third operating portion, the control portion clears the information related to printing of the provision information displayed on the first display screen.

Another object of the present invention is to provide the display-integrated image forming apparatus, wherein if a predetermine time elapses without the information related to printing of the provision information displayed on the first display screen being input to either the first operating portion or the third operating portion after clearing the display of the information related to printing of the provision information displayed on the first display screen, the control portion clears from the storage portion the information related to printing of the provision information displayed on the first display screen.

Another object of the present invention is to provide the display-integrated image forming apparatus, wherein in response to the completion of printing of the selected information by the printing portion, the control portion clears from the storage portion the information related to printing of the provision information displayed on the first display screen.

### BRIEF DESCRIPTION OF THE DRAWINGS

FIGS. 1A to 1C are perspective external views of an embodiment of a display-integrated image forming apparatus of the present invention;

FIGS. 2A and 2B are diagrams of an example of a situation when the display-integrated image forming apparatus is disposed in a convenience store;

FIGS. 3A to 3C are diagrams of operational images when a large-sized display according to the embodiment of the display-integrated image forming apparatus is vertically slid relative to a backside housing of the image forming apparatus;

FIGS. 3D to 3F are diagrams of operational images when a large-sized display is rotated by ±90 degrees along a backside housing of the image forming apparatus;

FIG. 4 is an exploded perspective view of a vertical movement mechanism of the large-sized display according to the embodiment of the display-integrated image forming apparatus;

FIG. 5 is an overhead view of the vertical movement mechanism of the large-sized display according to the embodiment of the display-integrated image forming apparatus;

FIG. 6 is a main part perspective view of a rotational movement mechanism of the large-sized display according to the embodiment of the display-integrated image forming apparatus;

FIG. 7 is an overhead view of the rotational movement mechanism of the large-sized display according to the embodiment of the display-integrated image forming apparatus;

FIGS. 8A and 8B are perspective external views of another embodiment of the display-integrated image forming apparatus of the present invention;

FIG. 9 is a diagram of another example when the display-integrated image forming apparatus of the present invention is disposed in a convenience store;

FIGS. 10A and 10B are perspective external views of yet another embodiment of the display-integrated image forming apparatus of the present invention;

FIG. 11 is a perspective external view of yet another embodiment of the display-integrated image forming apparatus of the present invention;

FIGS. 12A to 12D are perspective external views of yet another embodiment of the display-integrated image forming apparatus of the present invention;

FIG. 13 is a perspective external view of yet another embodiment of the display-integrated image forming apparatus of the present invention;

FIG. 14 is a block diagram of an example of an electrical configuration of the display-integrated image forming apparatus of the present invention;

FIG. 15 is a diagram of an explanatory external configuration of an operating portion in an image forming apparatus of the display-integrated image forming apparatus of the present invention;

FIG. 16 is a diagram of an example of an electrical configuration of a server apparatus providing information to the display-integrated image forming apparatus;

FIG. 17 is an explanatory diagram of an example when the display-integrated image forming apparatus of the present invention is disposed in a real-estate company;

FIGS. 18A and 18B are diagrams of display examples when real-estate property information is displayed on the display-integrated image forming apparatus of the present invention;

FIG. 19 is a diagram of a display example when certain property information is selected from the real-estate property information;

FIGS. 20A and 20B are diagrams of examples of a display screen prompting entry of a password and a display screen entering a print instruction when selecting property information;

FIGS. 21A and 21B are explanatory flowcharts of an example of a process executed by the display-integrated image forming apparatus of the present invention; and

FIG. 22 is an explanatory diagram of a typical disposition configuration of a convenience store.

### PREFERRED EMBODIMENTS OF THE INVENTION

Embodiments of the present invention will now be described with reference to the drawings.

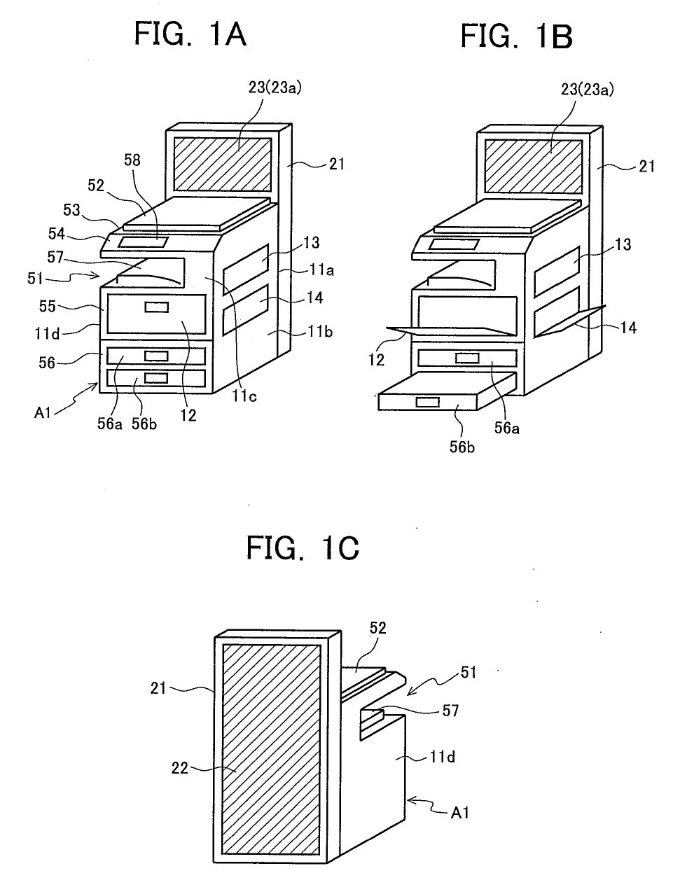

FIGS. 1A to 1C are perspective external views of an embodiment of a display-integrated image forming apparatus of the present invention.

This image forming apparatus A1 is an image forming apparatus having an in-body paper discharge structure formed in a laterally-facing U-shape when viewed from the front side and is disposed with a document pressing cover 52, a document reading portion 53, and a scanner portion 54 on the upper side of an in-body paper discharging portion 51 as well as an image forming portion 55 and a paper feeding portion 56 on the lower side of the in-body paper discharging portion 51. A keyboard typed and touch panel typed operating portion 58 is provided on the front side of the document reading portion 53.

The image forming apparatus A1 is surrounded by a backside housing 11a and a right-side housing 11b formed in a rectangular shape, a front-side housing in a substantially rectangular shape with a laterally-facing U-shape cutout due to the in-body paper discharging portion 51, and a left-side housing 11d and has a configuration covered at the upper sides of these housings by the scanner portion 54 including the document pressing cover 52 and the document reading portion 53. Although not shown, respective casters are provided on the four corners under the housings such that the image forming apparatus may freely be wheeled and moved.

The image forming apparatus A1 is a front access type that enables operations to be performed from the front side of the image forming apparatus when a document is placed on the document reading portion 53, when a recoding paper sheet is removed from a discharge tray 57 of the in-body paper discharging portion 51, and when recoding paper sheets are supplied to the paper feeding portion 56. A front door 12 is provided immediately below the in-body paper discharging portion 51 of the front-side housing 11c; side doors 13 and 14 are provided at two upper and lower locations in the right-side housing 11b; and paper feeding cassettes 56a and 56b of the paper feeding portion 56 are disposed below the front door 12 and capable of being pulled out toward the front side. Opening the front door 12 enables maintenance to be performed by supplying toner, replacing a photoreceptor, and restoring or replacing a fixing device or a charger, etc. If a jammed recording paper sheet is removed from a paper carrying path, the side doors 13 and 14 are openable as needed. However, except that the discharge tray 57 is disposed on the in-body paper discharging portion 51, the constituent potions disposed on the upper and lower side thereof are by way of example and are not limited to this disposition configuration.

In the above configuration, a large-sized displaying device (display) 21 is integrally attached to the backside housing 11a of the image forming apparatus A1 with a first display screen 22 facing outward and the longitudinal sides of the screen arranged vertically in this embodiment. The image forming apparatus A1 is utilized as a leg portion of the large-sized display 21 in this embodiment. Therefore, the disposition space of two large-sized devices, i.e., the image forming apparatus A1 and the large-sized display 21 may substantially be accommodated within the disposition space of the image forming apparatus A1.

As described above, although if a liquid crystal display as the displaying device and a digital multi-function peripheral as the image forming apparatus are serially arranged, a necessary footprint is, for example, an area defined by width: 917 mm of the liquid crystal display stand width×depth: 1540 mm (670 mm depth of the digital multi-function peripheral+870 mm depth of the liquid crystal display stand), the footprint may be reduced to width: 742 mm of the liquid crystal display width×depth: 762 mm (92 mm depth of the liquid crystal display+670 mm depth of the digital multi-function peripheral) if the liquid crystal display is mounted to the backside of the digital multi-function peripheral.

Although it is difficult to achieve a balance when the liquid crystal display is vertically disposed, the integration with the digital multi-function peripheral enables the stable disposition with a preferable weight balance between the digital multi-function peripheral and the liquid crystal display. Therefore, the display-integrated image forming apparatus may almost entirety be disposed in the place where the image forming apparatus is conventionally disposed even in space-limited stores such as convenience stores and supermarkets. In this case, if the displaying device is attached to, for example, the backside of the image forming apparatus with the display screen facing outward, the display screen of the displaying device faces to pedestrians outside the store through a wall glass toward the road (i.e., sidewalk) only by conventionally disposing the image forming apparatus in the store. Therefore, impressive promotion/advertisement may be performed for the pedestrians outside the store by displaying advertisement information on the display screen of the displaying device.

Since a connecting cord between the image forming apparatus A1 and the large-sized display 21 is not exposed outside, a neat appearance is achieved and a problem such as being tripped by the connecting cable does not occur. However, to be exact, a space is necessary for the thickness of the large-sized display 21 and the depths of a vertical movement mechanism and a rotational movement mechanism described later. Therefore, the display-integrated image forming apparatus of the present invention may almost entirety be disposed in the place where the image forming apparatus is conventionally disposed even in space-limited stores such as convenience stores and supermarkets.

The large-sized display 21 is disposed in such a way that the upper part thereof is projected above the backside housing 11a and a second display screen 23 is disposed on the surface of the projected portion opposite to the first display screen 22. However, although the second display screen 23 is not essential, it is more preferable to provide the second display screen 23 for the convenience of users. Although the first display screen 22 and the second display screen 23 are integrated in the above example, the screens may be disposed as separate displays.

The usability may be improved for users by utilizing the second display screen 23 as an operating portion and enabling any one or both of the operating portion of the second display screen 23 and the operating portion 58 to be operated.

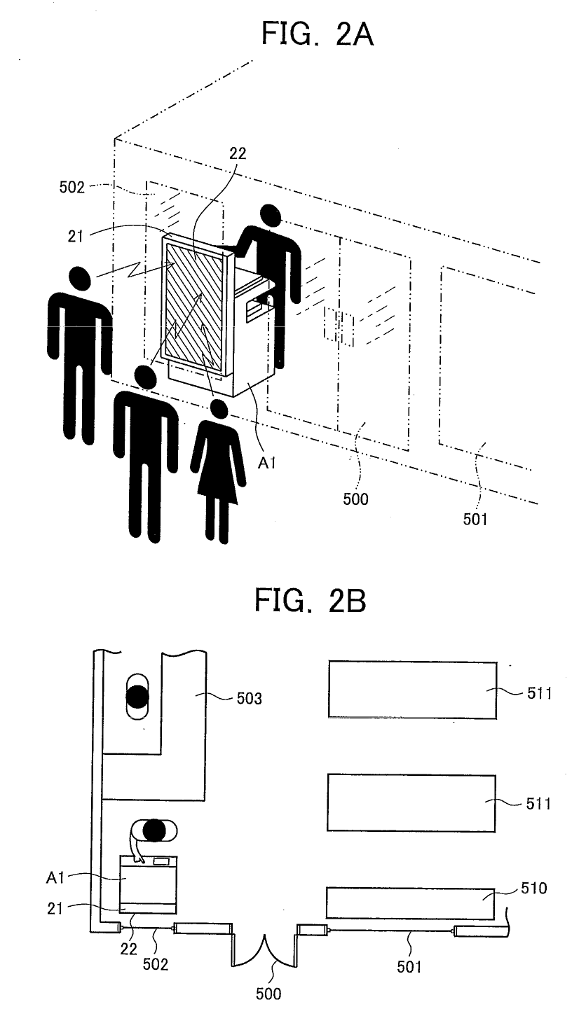

FIGS. 2A and 2B depict an example of a situation when the display-integrated image forming apparatus with the above configuration is disposed in a convenience store and FIGS. 2A and 2B are perspective and plan views, respectively.

A recent convenience store has a clear glass window as a fully glass-walled store portion facing the road (sidewalk) and merchandises are displayed such that pedestrians walking on the sidewalk can see at a glance how the inside of the store are. For example, a bookshelf 510 is disposed along a glass window 501 on the larger-space side, an image forming apparatus A1 is disposed along a glass window 502 on the smaller-space side across an entrance 500; a checkout counter 503 is disposed inside the store behind the image forming apparatus A1; and various merchandise shelves 511 are disposed inside the store behind the bookshelf 510 in a typical disposition pattern.

In this case, the image forming apparatus A1 is disposed such that the first display screen 22 of the large-sized display 21 attached to the backside faces toward the outside (i.e., the sidewalk outside the store). Therefore, the first display screen 22 of the large-sized display 21 faces to pedestrians outside the store through the glass window 502 toward the road (i.e., sidewalk). Therefore, impressive promotion/advertisement may be performed for the pedestrians outside the store by displaying advertisement information on the first display screen 22 of the large-sized display 21. In this case, the second display screen 23 may display the same information as the advertisement information displayed on the first display screen 22 disposed toward the sidewalk or the information (detailed information, etc.,) related to the advertisement information displayed on the first display screen 22.

As a result, when a pedestrian interested in the advertisement contents on the first display screen 22 comes in the store and in front of the image forming apparatus A1, the detailed information is displayed on the second display screen 23, and a touch panel of the second display screen 23 or the operating portion 58 of the image forming apparatus A1 may be operated to perform the printing of the desired information, etc. For example, when the first display screen 22 displays information indicative of issuance of a coupon ticket, a customer viewing the information may come in the store and operate (touch) a coupon ticket issuance button displayed on the second display screen 23 to print and output the coupon ticked with the image forming apparatus A1.

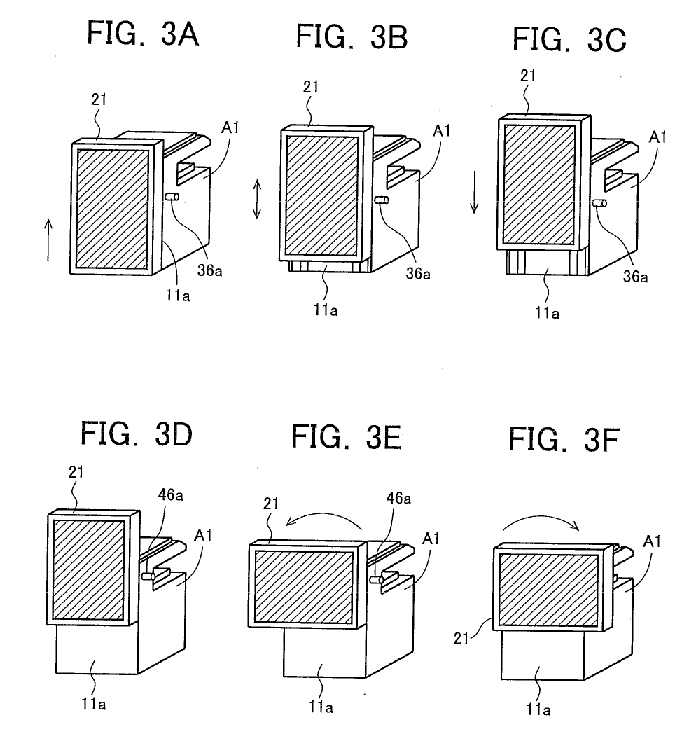

FIGS. 3A to 3C are diagrams of operational images when the large-sized display 21 of the embodiment is vertically slid relative to the backside housing 11a of the image forming apparatus A1, and FIGS. 3D to 3F are diagrams of operational images when the large-sized display 21 is rotated by ±90 degrees toward a horizontal direction along the backside housing 11a of the image forming apparatus A1.

Since the lower portion of the glass window 502 may be blinded or attached with another paper advertisement, etc., in some stores to be disposed with the display-integrated image forming apparatus, the large-sized display 21 may be made height-adjustable and height-position-fixable to be disposed at the optimum heights suitable for the stores as shown in FIGS. 3A to 3C. Similarly, it may be desirable to dispose the large-sized display 21 horizontally rather than vertically in some stores where the apparatus is disposed. Therefore, the large-sized display 21 may be made rotatable along the housing 11a of the image forming apparatus A1 and fixable at a predetermined angular position (90 degrees in this example) as shown in FIGS. 3D to 3F to achieve various disposition forms suitable for circumstances of stores.

### <Description of Display Vertical Movement Mechanism>

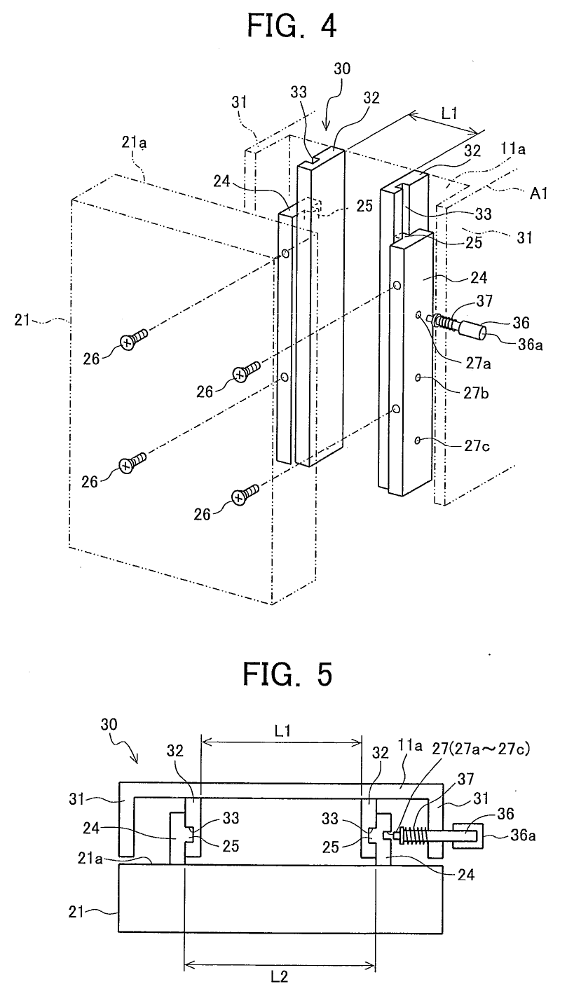

An embodiment of a configuration of a display vertical movement mechanism for enabling the vertical slide movement shown in FIGS. 3A to 3C will be described with reference to FIGS. 4 and 5. FIG. 4 is an exploded perspective view of a vertical movement mechanism 30 and FIG. 5 is an overhead cross-section view of the vertical movement mechanism 30.

A pair of rectangular holding plates 31 and 31 is provided to project backward in parallel and integrally formed on (or attached and fixed by screws, etc., to) both the left and right side portion of the backside housing 11a of the image forming apparatus A1, and a pair of rectangular guide rail plates 32 and 32 is provided to project backward in parallel with a predetermined interval L1 and integrally attached and fixed by screws not shown in the figure, etc., to the backside housing 11a surrounded by the holding plates 31 and 31. Single rail grooves 33 and 33 are respectively formed in the guide rail plates 32 and 32 on the backsides of the surfaces facing each other (i.e., the surfaces opposed to the holding plates 31) continuously from the upper to lower ends thereof.

On the other hand, a pair of rectangular display holding sliders 24 and 24 is provided to project forward in parallel with a predetermined interval L2 and attached and fixed by screws 26 to a backside housing 21a of the large-sized display 21. Single rail projections 25 and 25 continued from the upper to lower ends are respectively formed on the display holding sliders 24 and 24 on the surfaces facing each other and the rail projections 25 and 25 are respectively fit into and vertically slidably engaged with the rail grooves 33 and 33 of the guide rail plates 32 and 32. The predetermined intervals L1 and L2 are set to enable the smooth vertical slide movement while maintaining the engagement between the rail projections and the rail grooves 33.

One of the holding plates 31 (the right holding plate of FIGS. 4 and 5) is provided with a vertical movement fixing pin 36 for fixing the opposing display holding slider 24. The vertical movement fixing pin 36 is always biased toward the display holding slider 24 by a coil spring 37, and the height position of the display holding slider 24 may be fixed by engaging the vertical movement fixing pin 36 with any one of a plurality of fixing holes 27 (three holes 27a, 27b, and 27c in this embodiment) formed in the opposing outer surface of the display holding slider 24 to adjust the height position of the large-sized display 21.

An operating method will then be described for the case of changing the height position of the large-sized display 21 from, for example, FIGS. 3A to 3B.

First, a handle portion 36a of the vertical movement fixing pin 36 provided in the-holding plate 31 is pulled to elastically compress the coil spring 37 to disengage the vertical movement fixing pin 36 from the fixing hole 27a of the display holding slider 24. This makes the display holding slider 24 slidably movable. While the handle portion 36a of the vertical movement fixing pin 36 is being pulled, the large-sized display 21 is elevated to the position of FIG. 3B and the handle portion 36a of the vertical movement fixing pin 36 is released from the pulling state. The vertical movement fixing pin 36 then engages with the fixing hole 27b of the display holding slider 24 due to the bias force (elastic resilience) of the coil spring 37 provided on the vertical movement fixing pin 36 and the large-sized display 21 is fixed at the position of FIG. 3B.

Although the handle portion 36a is continuously pulled after the vertical movement fixing pin 36 is disengaged from the fixing hole 27a of the display holding slider 24 until the vertical movement fixing pin 36 is engaged with the next fixing hole 27b in the above operation description, the handle portion 36a may be released from the pulling state when the display holding slider 24 is slightly slid upward after the vertical movement fixing pin 36 is disengaged from the fixing hole 27a. As a result, while the display holding slider 24 is slowly elevated, when the tip of the vertical movement fixing pin 36 matches the next fixing hole 27b, the vertical movement fixing pin 36 automatically engages with the fixing hole 27b due to the bias force (elastic resilience) of the coil spring 37.

### <Description of Display Rotational Mechanism>

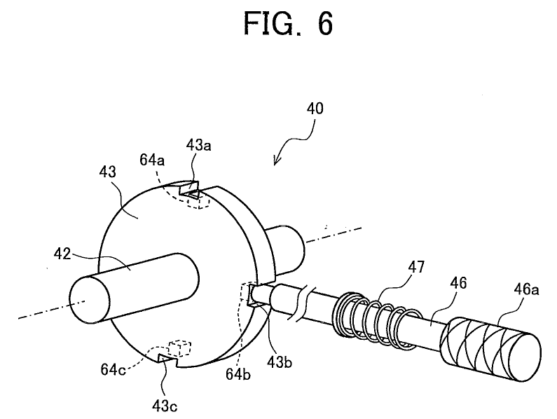

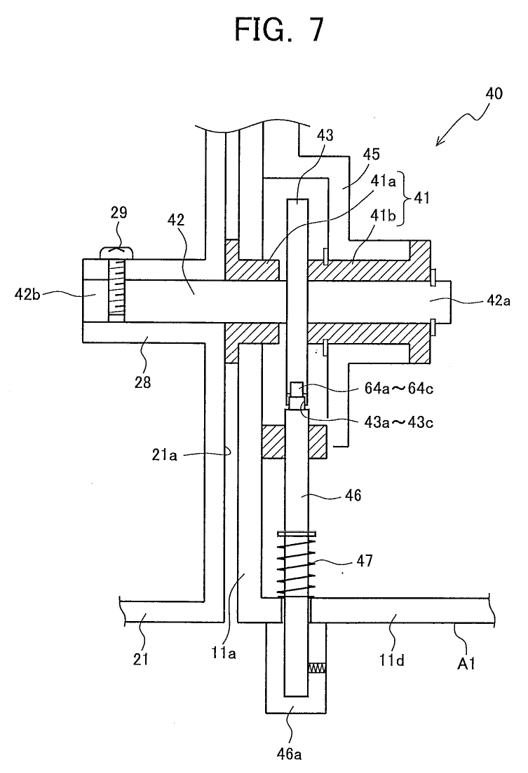

An embodiment of a configuration of a display rotational movement mechanism for enabling the rotational movement shown in FIGS. 3D to 3F will be described with reference to FIGS. 6 and 7. FIG. 6 is a main part perspective view of a rotational movement mechanism 40 and FIG. 7 is an overhead cross-section view of the rotational movement mechanism 40.

The large-sized display 21 provided on the backside housing 11a of the image forming apparatus A1 may be rotated clockwise from the vertical display state (FIG. 3D) by ±90 degrees to the horizontal display states (FIGS. 3B and 3C) as shown in FIGS. 3D to 3F to hold the large-sized display 21 in the user's desirable orientation.

The rotational movement mechanism 40 in this embodiment for implementing this movement is configured to support one end 42a of a rotation shaft 42 with a bearing portion 41 provided in the backside housing 11a of the image forming apparatus A1 and support and fix the other end 42b of the rotation shaft 42 in the backside housing 21a of the large-sized display 21. A cylindrical holding portion 28 for supporting and fixing the other end 42b of the rotation shaft 42 is provided in the backside housing 21a of the large-sized display 21, and the large-sized display 21 is integrally supported and fixed to the rotation shaft 42 by screwing a screw 29, etc., into the rotation shaft 42 from the circumferential surface of the holding portion 28 while the other end 42b of the rotation shaft 42 is inserted into the holding portion 28.

On the other hand, the bearing portion 41 provided in the backside housing 11a of the image forming apparatus A1 is made up of a first bearing portion 41a supported and fixed to the backside housing 11a and a second bearing portion 41b supported and fixed to a bearing sporting plate 45 provided within the backside housing 11a, and the one end 42a of the rotation shaft 42 is supported by the first bearing portion 41a and the second bearing portion 41b. The rotation shaft 42 between the first bearing portion 41a and the second bearing portion 41b is integrally provided with a rotation disk 43 provided with a pin groove 43a, a pin groove 43b, and a pin groove 43c in a circumferential portion at intervals of 90 degrees.

On the other hand, the left-side housing 11d of the image forming apparatus A1 is provided with a rotation fixing pin 46 for fixing the rotational position of the rotation shaft 42. The rotation fixing pin 46 is always biased toward the rotation disk 43 by a coil spring 47, and the large-sized display 21 may be held at each of positions at zero degrees, 90 degrees, and −90 degrees in clockwise direction as shown in FIGS. 3D to 3F by engaging the rotation fixing pin 46 with any one of the three pin grooves 43a, 43b, and 43c provided in the circumferential portion of the rotation disk 43 to fix the rotation position of the rotation disk 43 (i.e., the rotation position of the rotation shaft 42).

An operating method will then be described for the case of rotating the rotational angular position of the large-sized display 21 from the position at zero degrees in clock wise direction (position shown in FIG. 3D) to the position at −90 degrees in clock wise direction (position of FIG. 3E).

First, a handle portion 46a of the rotation fixing pin provided in the left-side housing 11d of the image forming apparatus A1 is pulled to elastically compress the coil spring 47 to disengage the rotation fixing pin 46 from the pin groove 43b of the rotation disk 43. This makes the rotation shaft 42 rotatably movable. While the handle portion 46a of the rotation fixing pin 46 is being pulled, the large-sized display 21 is rotated clockwise by −90 degrees to the position of FIG. 3E and the handle portion 46a of the rotation fixing pin 46 is released from the pulling state. The rotation fixing pin 46 then engages with the pin groove 43c of the rotation disk 43 due to the bias force (elastic resilience) of the coil spring 47 provided on the rotation fixing pin 46 and the large-sized display 21 is fixed at the position of FIG. 3E.

Similarly, while the handle portion 46a of the rotation fixing pin 46 is being pulled to elastically compress the coil spring 47 to disengage the rotation fixing pin 46 from the pin groove 43b of the rotation disk 43, if the large-sized display 21 is rotated clockwise by +90 degrees to the position of FIG. 3F, the rotation fixing pin 46 engages with the pin groove 43a of the rotation disk 43.

Although the handle portion 46a is continuously pulled after the rotation fixing pin 46 is disengaged from the pin groove 43b of the rotation disk 43 until the rotation fixing pin 46 is engaged with the next pin groove 43c in the above operation description, the handle portion 46a may be released from the pulling state when the rotation shaft 42 is slightly rotated counterclockwise after the rotation fixing pin 46 is disengaged from the pin groove 43b. As a result, while the rotation shaft 42 is rotated counterclockwise, when the tip of the rotation fixing pin 46 matches the next pin groove 43c, the rotation fixing pin 46 automatically engages with the pin groove 43c due to the bias force (elastic resilience) of the coil spring 47.

Although the display vertical movement mechanism 30 and the display rotation mechanism 40 are separately provided in the description of the above mechanisms, the both mechanisms may integrally be provided.

As a result, since the vertical movement shown in FIGS. 3A to 3C and the rotational movement shown in FIGS. 3D to 3F may be achieved in combination, a flexible disposition configuration may be implemented in accordance with the disposition conditions of stores.

Other embodiments will then be described such as various disposition configurations of the display-integrated image forming apparatus and shapes of the large-sized display 21.

For example, in FIGS. 3D to 3F, the center of rotation is somewhat lower than the center portion of the large-sized display 21. Therefore, if the large-sized display 21 is rotated, one side of the large-sized display 21 is protruded from the width of the backside housing 11a of the image forming apparatus A1 as shown in FIGS. 3E and 3F. However, convenience stores, etc. provide the copying for pay and a charging device for this purpose is normally disposed along the side of the image forming apparatus A1. Therefore, if the width of the protrusion of the large-sized display 21 is substantially the same as the disposition width of the charging device, no problem occurs when the large-sized display 21 is horizontally disposed.

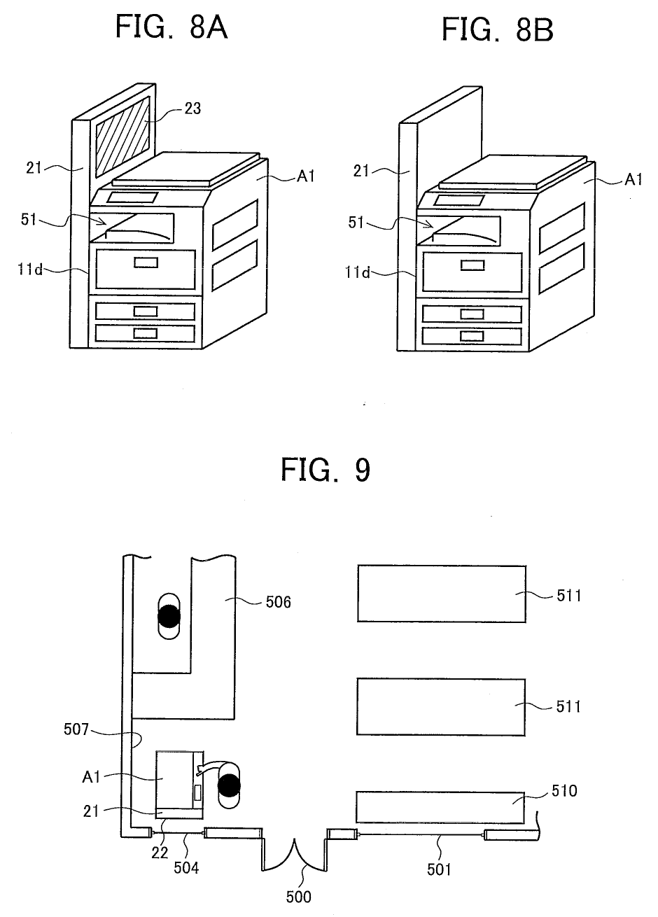

Although the large-sized display 21 is attached to the backside of the image forming apparatus A1 in the description of the above embodiment, the large-sized display 21 may be attached to the one side housing 11d of the image forming apparatus A1, for example, as shown in FIG. 9 as long as no trouble is caused at the times of reading a document, taking out a sheet from the discharge tray, opening/closing the doors for supplying recording paper sheets into the paper feeding cassette and for maintenance, etc. FIG. 8A exemplarily illustrates the case that the second display screen 23 is included and FIG. 8B exemplarily illustrates the case that the second display screen 23 is not included.

FIG. 9 depicts an example when the image forming apparatus A1 shown in FIGS. 8A and 8B is disposed in a convenience store. In this example, the image forming apparatus A1 is disposed sideways to a glass window 504 along the glass window 504 on the smaller-space side by the entrance 500 such that the first display screen 22 of the large-sized display 21 attached to the side surface faces toward the outside (i.e., the sidewalk outside the store). The image forming apparatus A1 is disposed with the backside facing toward a wall 507. This is a disposition form effective when an operation space for a user of the image forming apparatus A1 cannot be ensured between the glass window 504 and a checkout counter 506 and such a disposition form becomes available when the large-sized display 21 is attached to the side surface of the image forming apparatus A1.

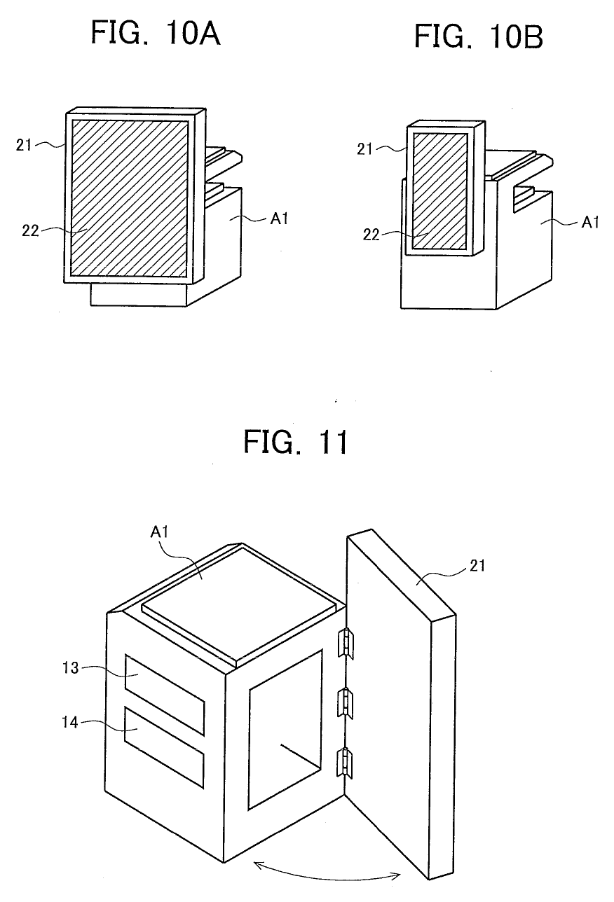

Although the width of the large-sized display 21 is set identical to the width of the image forming apparatus A1 when the large-sized display 21 is vertically disposed, the widths may not be identical. For example, the width of the large-sized display 21 may somewhat be wider than the width of the image forming apparatus A1 as shown in FIG. 10A or the width of the large-sized display 21 may be narrower than the width of the image forming apparatus A1 as shown in FIG. 10B.

The large-sized display 21 may also be used as an opening/closing door for opening/closing one side of the image forming apparatus A1. For example, by supporting one side portion of the backside housing 11a of the image forming apparatus A1 and one side portion of the backside of the large-sized display 21 by hinges, etc. in an openable and closable manner, the backside of the image forming apparatus A1 may be opened and closed as shown in FIG. 11. This facilitates the maintenance operations and the removal of a jammed sheet since the large-sized display 21 is openable at the time of maintenance or when a recording paper sheet is jammed on the carriage path. When the large-sized display 21 is also used as the door opened to reveal the inside of the image forming apparatus A1, the conventional side doors 13 and 14 may be omitted.

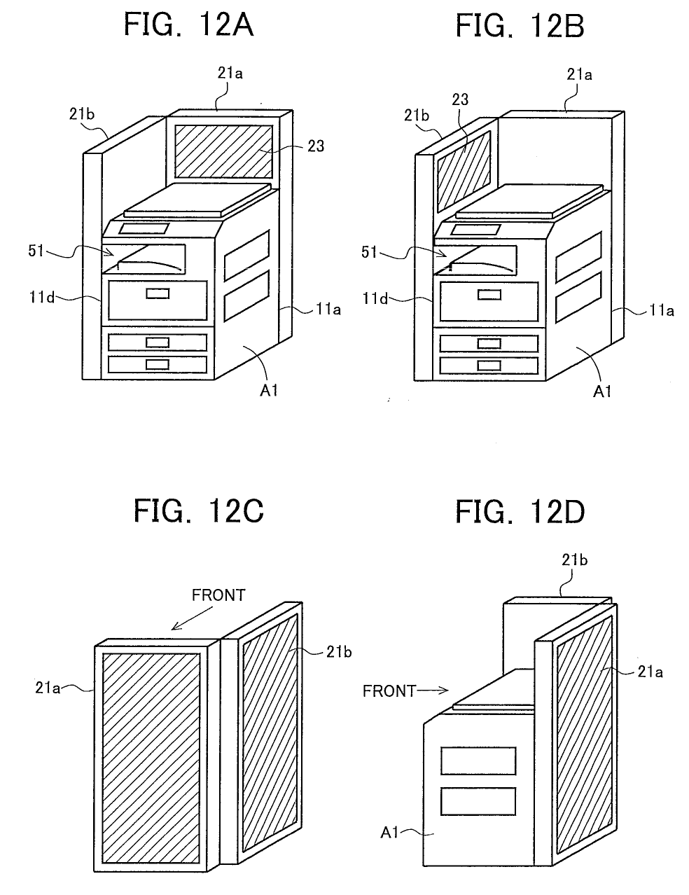

Although the large-sized display 21 is attached to the backside housing 11a or the side housing 11d of the image forming apparatus A1 in the description of the above embodiment, the large-sized displays 21 may be disposed on the backside housing 11a and the side housing 11d as shown in FIGS. 12A to 12D, for example. In this case, both display screens of two large-sized displays 21a and 21b function as the first display screens 22.

FIG. 12A exemplarily illustrates the case that the second display screen 23 is included in the large-sized display 21a attached to the backside housing 11a and that the second display screen 23 is not included in the large-sized display 21b attached to the side housing 11d, and FIG. 12B exemplarily illustrates the case that the second display screen 23 is not included in the large-sized display 21a attached to the backside housing 11a and that the second display screen 23 is included in the large-sized display 21b attached to the side housing 11d. Although the second display screen 23 is provided on either the large-sized display 21a or 21b, the second display screen 23 may be provided on both or none of the displays.

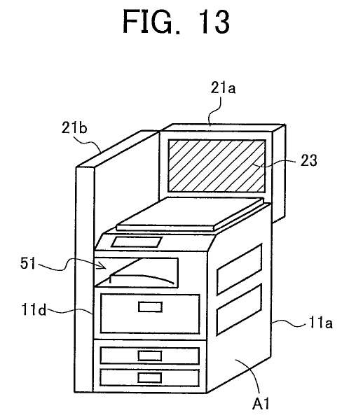

Although the second display screen is disposed on the backside of the display screen of the large-sized display 21 in the above embodiment, the large-sized display 21 may be disposed on the side housing of the image forming apparatus A1 and the second display screen may be disposed to be protruded from the backside of the image forming apparatus A1 as shown in FIG. 13, for example.

### Description of System Configuration of Display-Integrated Image Forming Apparatus of the Embodiment

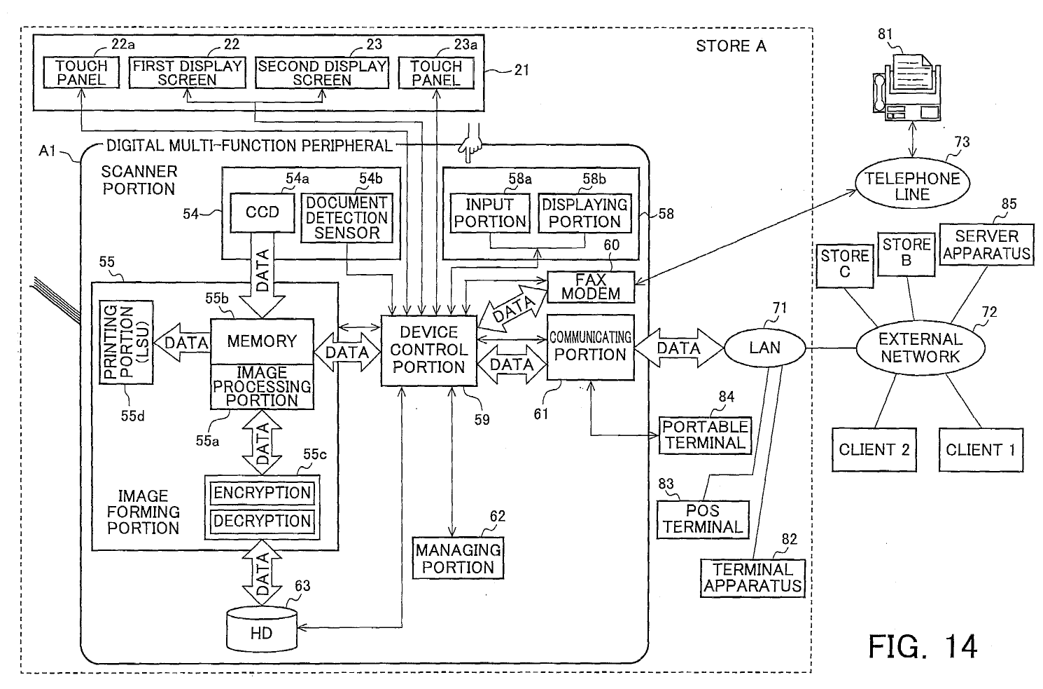

The case of applying the display-integrated image forming apparatus with the above configuration to a digital multi-function peripheral will be described in the embodiment. FIG. 14 depicts a schematic of an electrical configuration of such a digital multi-function peripheral and a connection relationship between the digital multi-function peripheral and an external server apparatus 85 that manages display information.

The electrical configuration of a digital multi-function peripheral (image forming apparatus) A1 will first be described.

As shown in FIG. 14, the digital multi-function peripheral A1 includes a scanner portion 54, an operating portion 58, an image forming portion 55, a device control portion 59, a FAX modem 60, a communicating portion 61, a managing portion 62, and a hard disk (HD) 63. The digital copy machine A1 of the embodiment is a multi-function peripheral combined with FAX and a network printer.

The scanner portion 54 includes a CCD 54a, a document detection sensor 54b, etc., and corresponds to a document reading portion of the present invention.

The operating portion 58 includes an input portion 58a consisting of various function buttons that are a touch panel and mechanical keys described later and a displaying portion 58b consisting of a display panel of liquid crystal, etc. The operating portion 58 corresponds to a first operating portion of the present invention.

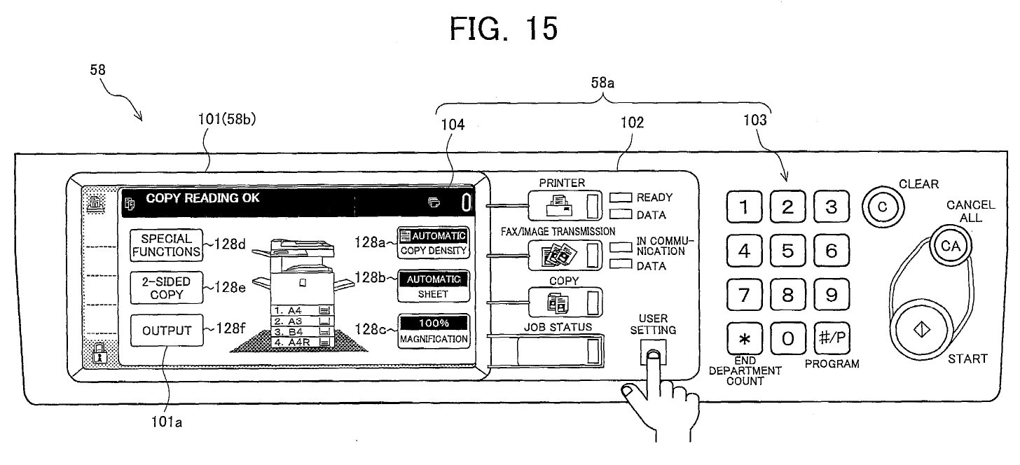

FIG. 15 depicts an explanatory external configuration of the operating portion 58. The displaying portion 58b has a configuration including a transparent touch panel 104 disposed on the upper surface of a display panel 101, and various function keys 102 and a ten key 103 are disposed on the side (the right side in FIG. 15) of the displaying portion 58b. This configuration also includes a start button, a cancel all (CA) button, and a clear (C) button disposed on the right side of the ten key 103. The touch panel 104 enables operational input to the display screen of the display panel 101.

Description will be made with reference to FIG. 14 again. The image forming portion 55 includes an image processing portion 55a having a working memory (storage portion) 55b for developing print data, an encrypting/decrypting portion 55c that encrypts and temporarily saves (stores) the data from the outside into the hard disk 63 to protect the data within the device and that decrypts and delivers the data saved in the hard disk 63 to the image processing portion 55a, a printing portion 55d having a laser scanning unit (LSU). The printing portion 55d is not limited to an electrophotographic mode and is applicable to various forms such as an ink-jet mode and a thermal-transfer mode. The printing portion 55d corresponds to a printing portion of the present invention.

The device control portion 59 is a portion that manages the operation control for the whole device and corresponds to a control portion of the present invention. The device control portion 59 is made up of CPU, ROM, RAM, etc., and performs the display control including the display control for the displaying portion 58b as well as the display control of the first display screen 22 and the second display screen 23 of the large-sized display 21.

Touch panels 22a and 23a are respectively disposed on the upper surfaces of the first display screen 22 and the second display screen 23 to constitute a second operating portion and a third operating portion, respectively, in addition to the operating portion 58 (the first operating portion).

The managing portion 62 is a portion that manages information necessary for the operation of the device and performs management of e-mail addresses and management of telephone numbers for FAX with regard to transmission/reception, for example. The managing portion 62 performs collective management of information necessary for the operation of the device such as management of location information (address information) of data temporarily saved in the hard disk 63 and management of location information of data to be output to the printer in the case of operation in the printer mode.

The communicating portion 61 is a communicating portion that performs two-way communication between a LAN 71 and an external network 72 and is a printer board including a memory for developing received data to data that can be handled by the device in this embodiment. Therefore, the communicating portion 61 sequentially transfers data to the working memory 55b while developing the received data onto the memory.

In the digital multi-function peripheral A1 with the above configuration, the FAX modem 60 is connectable to a facsimile apparatus 81 through a telephone line 73. The communicating portion 61 is connectable to a terminal apparatus (personal computer) 82, a POS terminal 83, etc., through the LAN 71 and is also connectable to a portable terminal 84 through wireless connection. The communicating portion 61 is connectable to the external server apparatus 85, external branches (store B and store C), etc., through the external network 72. The external network is also connected with a client 1 and a client 2 to make a request for displaying advertisement, etc., to the server apparatus 85. The digital multi-function peripheral A1 of this embodiment is disposed in a network environment as above.

The external server apparatus 85 basically manages various pieces of information displayed on the first display screen 22 and the second display screen of 23 the large-sized display 21, the order of the display, the display time, etc.

Although the one large-sized display 21 is disposed in a store A, a plurality of the large-sized displays 21 may be disposed and the external server apparatus 85 may manage the display on the plurality of the large-sized displays 21.

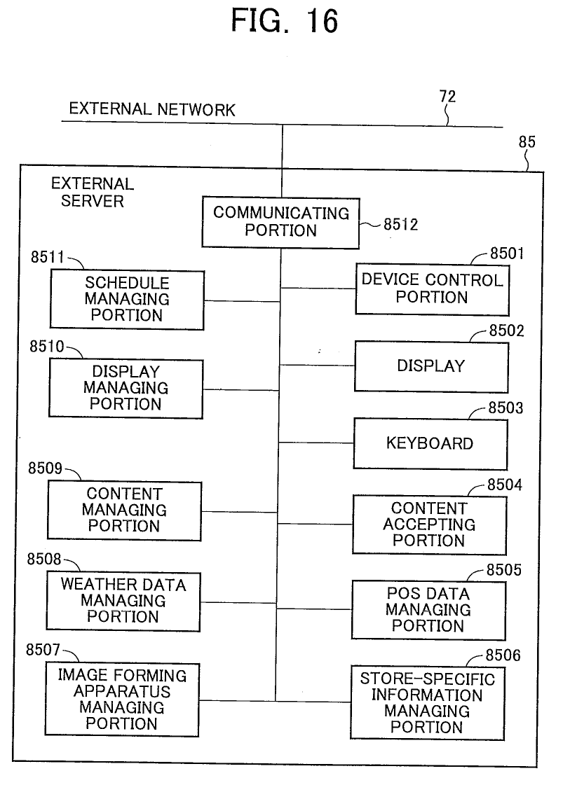

FIG. 16 depicts a schematic of an electrical configuration of the server apparatus 85.

The server apparatus 85 includes a device control portion 8501, a display 8502, a keyboard 8503, a content accepting portion 8504, a POS data managing portion 8505, a store-specific information managing portion 8506, an image forming apparatus managing portion 8507, a weather data managing portion 8508, a content managing portion 8509, a display managing portion 8510, a schedule managing portion 8511, and a communicating portion 8512.

The device control portion 8501 is a portion that manages the operation control for the whole server apparatus and is made up of CPU, ROM, RAM, etc., although not shown. The display 8502 displays statuses of the displaying apparatuses, and the image forming apparatuses of the stores managed by the server apparatus 85, etc. The keyboard 8503 is for the purpose of entering control instructions, to the display apparatuses of the stores from the server apparatus 85, etc.

The content accepting portion 8504 accepts advertisements requested from the client 1, the client 2, etc., display information such as coupon ticket information, and display request information from the stores through the external network 72 or information directly input to the server apparatus 85. The POS data managing portion 8505 accepts and manages information from the POS terminals 83 of the stores. The store-specific information managing portion 8506 stores and manages local information such as local events input from the terminal apparatuses 82 of the stores.

The image forming apparatus managing portion 8507 stores and manages the counter information and the operational status of the image forming apparatus. The weather data managing portion 8508 acquires and manages information from an organization not shown in the figure that manages weather information (e.g., Japan Meteorological Agency) through the external network 72. The content managing portion 8509 stores information accepted by the content accepting portion 8504. The display managing portion 8510 manages the split display, the overlapping display, etc. of the display screens of the displaying apparatuses of the stores.

The schedule managing portion 8511 stores and manages the display order, the display time, etc. of the information stored in the content managing portion 8509 for each of the stores disposed with the large-sized displays 21. The schedule managing portion 8511 manages the advertisement display contents based on the merchandise sales status of each stores, the customer types of purchased merchandises, etc. stored in the POS data managing portion 8505 and the switching of advertisement contents depending on a time zone, the switching of advertisement display contents based on information such as local weather and temperature stored in the weather data managing portion 8508, the switching of advertisement display contents based on information such as local events stored in the store-specific information managing portion 8506, etc.

The schedule managing portion 8511 also manages whether display data such as advertisement to be displayed is a moving image or still image and, in the case of a moving image, the data is transferred and stored in the HD 63 of the digital multi-function peripheral A1 in each of the stores and invoked and displayed from the HD 63 of the digital multi-function peripheral A1 in each of the stores at the timing following the display schedule of the schedule managing portion 8511. This enables smooth image display without the effect of data transfer from the server apparatus 85. On the other hand, the still image data is directly transferred from the content managing portion 8509 of the server apparatus 85 and displayed on the display apparatus in each of the stores.

The communicating portion 8512 is a communicating portion that performs two-way communication with the external network 72 and delivers the information stored in the content managing portion 8509 to the large-sized displays 21 of the stores based on the information stored in the schedule managing portion 8511. Alternatively, the information transmitted to the server apparatus 85 is once stored in the RAM of the device control portion 8501 and transferred to locations in accordance with the contents of the information transmitted from the device control portion 8501.

In the embodiment, information such as advertisement is displayed on the large-sized display 21 under the management of the server apparatus 85.

### <Description of Case of Printing Out Various Data Displayed on Large-Sized Display>

An example will then be described for the case that desired data is printed out from the digital multi-function peripheral A1 by a customer, etc., who watches various data displayed on the large-sized display 21 in the display-integrated image forming apparatus with the above configuration.

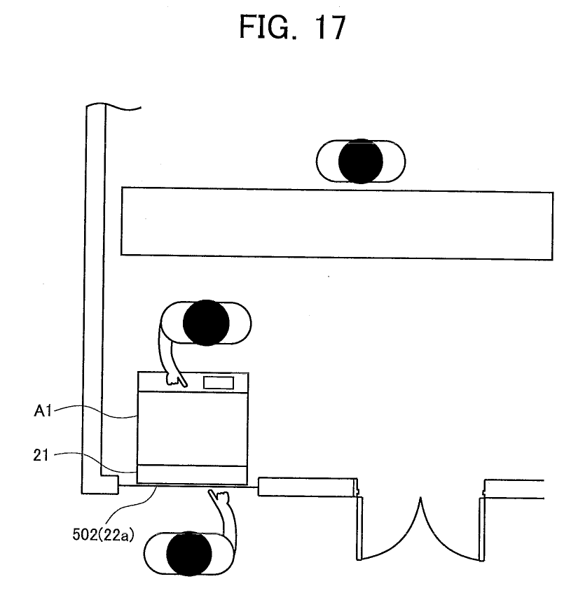

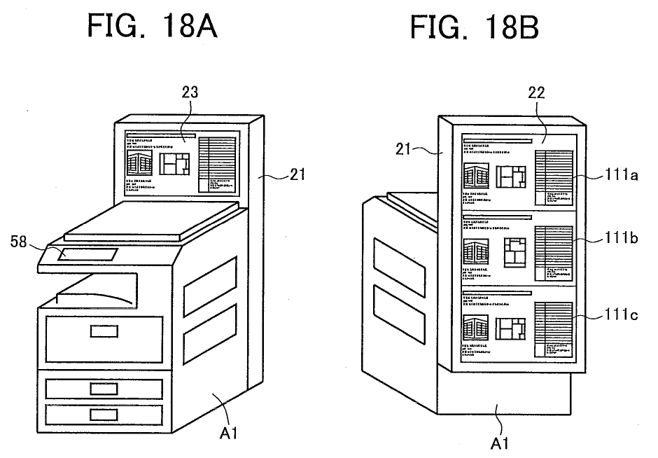

FIGS. 17 to 18B are explanatory diagrams of an embodiment when the display-integrated image forming apparatus of the present invention is applied to a real-estate company; FIG. 17 is a plan view when the display-integrated image forming apparatus of the present invention is disposed; and FIGS. 18A and 18B depict examples of displaying real-estate property information.

Real-estate companies recently also employ a technique of using fully glass-paned walls facing sidewalks and affixing advertisements on the glass surfaces as in the convenience stores. Therefore, promotion/advertisement of real-estate information may be performed by disposing the first display screen 22 of the large-sized display 21 of the display-integrated image forming apparatus of the present invention adjacent to the glass surface as is the case with the convenience stores. The promotion/advertisement of real-estate information is an example of provision information according to the present invention.

Although the touch panel 22a is disposed on the upper surface of the first display screen 22 in the above embodiment, a sensor portion of the touch panel 22a is affixed to the glass surface 502 outside the store in FIG. 17. Therefore, the large-sized display 21 and the image forming apparatus A1 itself may be protected. In this example, the second operating portion for performing operational input to the display of the first display screen is implemented by the touch panel 22a affixed to the outside of the glass surface 502.

For example, when the first display screen 22 displays three pieces of property information as shown in FIG. 18B, if a pedestrian watching the property information wants property information 111a, the pedestrian may touch the display location of the property information 111a on the first display screen 22 to select the property information 111a. The pedestrian may operate the touch panel 22a configured as the second operating portion to select the provision information displayed on the first display screen 22.

Although three pieces of property information are displayed in the above embodiment, more pieces of property information may be displayed by switching the display of information over time to display property information other then these three pieces.

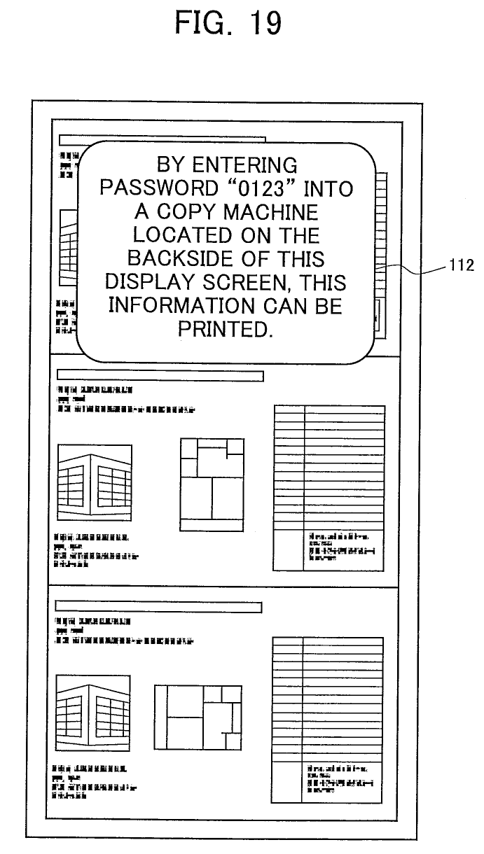

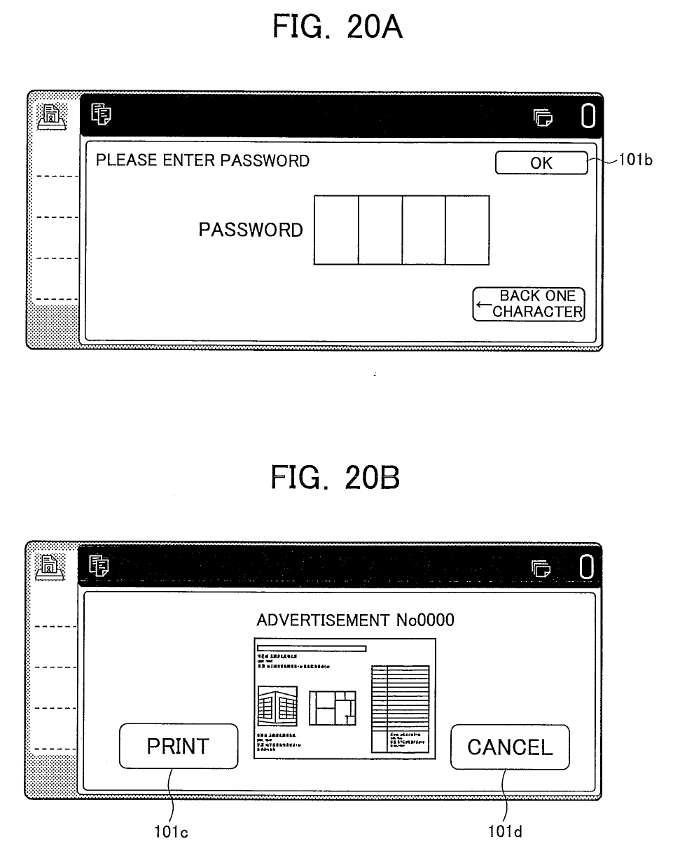

FIG. 19 displays switch-over of display when the property information 111a displayed on the first display screen in FIG. 18B is selected. When the property information 111a is selected, the display location of the property information 111a of the first display screen 22 is used for displaying “BY ENTERING PASSWORD “0123” INTO A COPY MACHINE LOCATED ON THE BACKSIDE OF THIS DISPLAY SCREEN, THIS INFORMATION CAN BE PRINTED” to display a method of receiving the information of the selected property information as a print. The password is an example of information related to printing of the provision information of the present invention and the password displayed upon selection of the property information 111a is information related to printing of the provision information selected.

If a person watching the display shown in FIG. 18B and selecting the information of the property information 111a (hereinafter, “operator”) really wants printed information of the property information 111a, the operator comes in the store and in front of the image forming apparatus A1 to start operation of the operating portion 58 for acquiring the printed information.

The operation of the image forming apparatus A1 for acquiring the printed information of the property information will be described with reference to FIG. 15 again. First, the operator pushes an “OUTPUT” 101a on the display panel 101 of the operating portion 58. This means pushing the touch panel 104 at the display portion of the “OUTPUT” 101a. When the “OUTPUT” 101a is pushed, the screen displayed on the display panel 101 is switched to a screen shown in FIG. 20A. When the displayed password is input and an “OK” 101b is pushed, the display screen on the display panel 101 is switched to a screen shown in FIG. 20B.

When the property information is displayed as shown in FIG. 20B, the operator checks the displayed property information to input a “PRINT” 101c if the information is identical to the information selected by the operator. If the information is not identical to the information selected by the operator or becomes unnecessary, the operator c input a “CANCEL” 101d.

If the “PRINT” 101c is input, the printed information of the desired property is printed and output by the image forming apparatus A1. The information to be printed (print information) may be the same as the information displayed on the first display screen 22 or may be related information of the displayed information (e.g., map around the property information and daily life information of the neighborhood). In this example, the information to be printed is information preliminarily correlated with the provision information selected (e.g., real-estate information).

Although the password is input through the operating portion 58 of the image forming apparatus A1 in this example, the touch panel 23a of the second display screen 23 may be used for acquiring a print.

For example, if the operator watches the display shown in FIG. 18B and selects the information of the property information 111a, the control portion of the image forming apparatus A1 displays a screen that enables input of an instruction for the output (e.g., FIG. 15) on the second display screen 23. If the operator gives an instruction for the output, switch-over to the screen as shown in FIG. 20A is performed to prompt entry of the password. When the operator correspondingly inputs the password and pushes “OK” on the second display screen 23, the second display screen 23 is switched to a screen as shown in FIG. 20B. The operator may input the print to print the related information of the selected information.

Alternatively, both the display panel 101 and the second display screen 23 may be used to prompt operational input. For example, if the operator watches the display shown in FIG. 18B and selects the information of the property information 111a, the display panel 101 of the image forming apparatus A1 displays a screen that enables input of an instruction for the output (e.g., FIG. 15). When the operator gives an instruction for the output, the second display screen 23 displays the screen that prompts entry of the password. When the operator correspondingly inputs the password and pushes “OK” on the second display screen 23, the second display screen 23 is switched to a screen as shown in FIG. 20B. The operator may input the print to print the related information of the selected information.

Alternatively, the same screens or similar screens may be displayed on the display panel 101 and the second display screen 23 such that the operator may perform the input through either screen.

The configuration including the third operating portion accepting the operational input to the second displaying screen 23 is configured such that the information related to printing of provision information (password in this example) may be input to one or both of the first operating portion of the operating portion 58 of the image forming apparatus A1 and the above third operating portion.

With the above configuration, since a person desiring to print the information displayed on the first display screen 23 may only select the display itself to select the information and only the person desiring the selected information performs the printing, printout of unnecessary information may be eliminated.

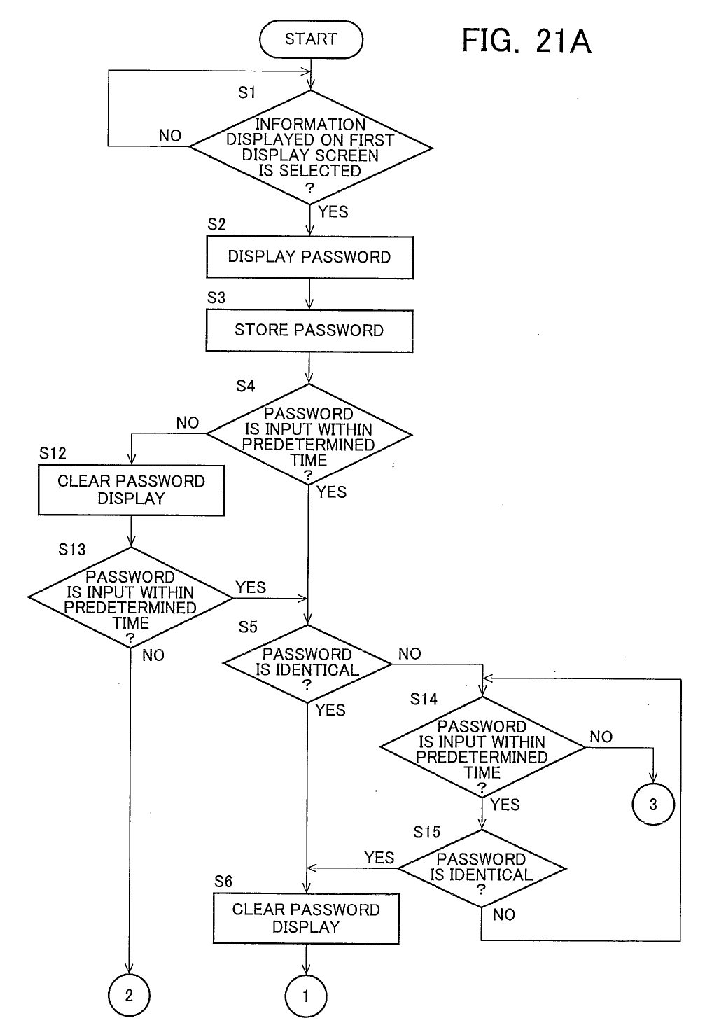

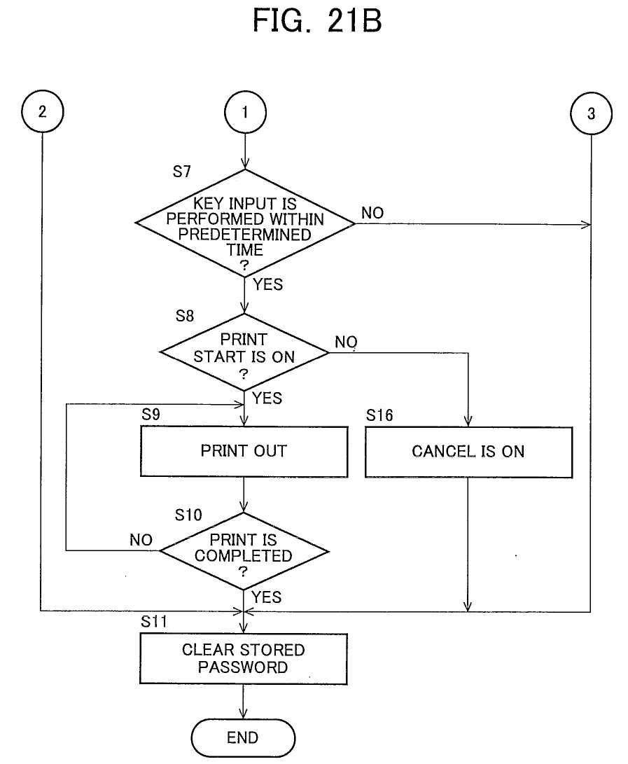

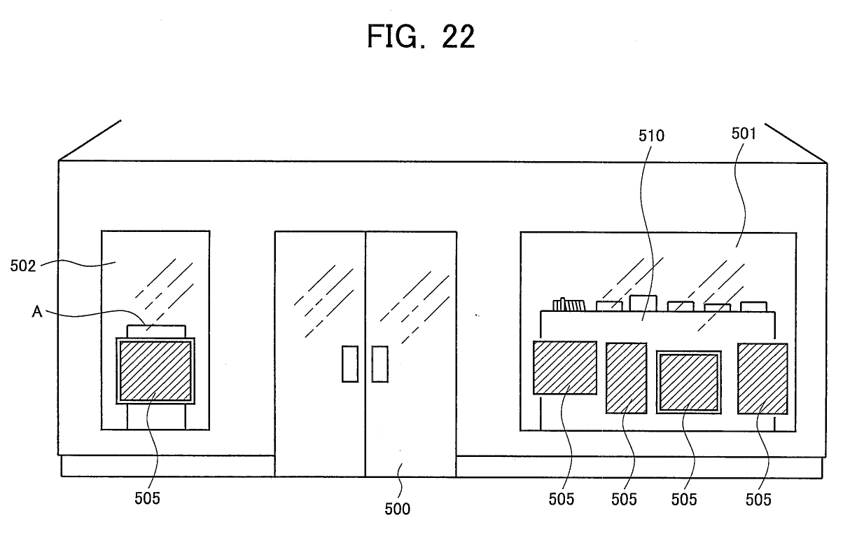

FIGS. 21A and 21B are explanatory flowcharts of an example of a print process by the display-integrated image forming apparatus of the present invention.

If information displayed on the first display screen 22 is selected in the display-integrated image forming apparatus (step S1), a password for printing the selected information is displayed on the first display screen 22 (step S2). The displayed password is stored in the managing portion of the image forming apparatus A1 (step S3).

The display-integrated image forming apparatus determines whether the password is input with the use of the operating portion 58 of the image forming apparatus A1 or the touch panel 23a of the second display screen 23 within a predetermined time after the password is displayed (step S4). If the password is input within the predetermined time, it is further determined whether the input password is identical to the password stored in the managing portion 62 at step S3 (step S5). If the password is identical, the password displayed on the first display screen 22 is cleared (step S6) and it is determined whether the next key input is performed within a predetermined time (step S7).

If the next key input is performed within the predetermined time, it is determined whether the key input is the input indicating that print start is turned ON through the print key (step S8). In the case of the input indicating that print start is turned ON, the display-integrated image forming apparatus executes the printout (step S9). Once the printout is completed (step S10, YES), the password stored in the managing portion 62 is cleared (step S11) and the print process is terminated.

If the password is not input within the predetermined time at step S4, the password displayed on the first display screen 22 is cleared (step S12) and it is determined whether the password is input within a predetermined time after the password is cleared (step S13). Since the property information is hidden and the advertising effect is reduced if the first display screen 22 continuously displays the password regardless of the absence of the input of the password, the display is once cleared to wait the input of the password again if the password is not input within the predetermined time.

If the password is input within the predetermined time at step S13, the process goes to step S5 to determine whether the input password is identical to the password stored in the managing portion 62. If the password is not input within the predetermined time, the process goes to step S11 to clear the password stored in the managing portion 62 and the print process is terminated.

If the input password is not identical to the password stored in the managing portion 62 at step S5 and if a password is input again within that predetermined time (step S14, YES), it is checked again whether the password is identical (step S15). If the password is identical, the process goes to step S6 to clear the password displayed on the first display screen 22. If the password is not input within the predetermined time at step S14, the process goes to step S11 to clear the password stored in the managing portion 62 and the print process is terminated.

If the key input is not performed within a predetermined time after the password is cleared at step S7, the process goes to step S11 to clear the password stored in the managing portion 62 and the print process is terminated.

If the key input does not indicate that print start is turned ON through the print key at step S8, the input key is a cancel key (cancel is ON) and the process goes to step S11 to clear the password stored in the managing portion 62 and the print process is terminated.

In the display-integrated image forming apparatus of the above embodiment, the large-sized display 21 is rotatably provided along the apparatus housing 11 of the digital multi-function peripheral. Therefore, the device control portion 59 must switch the display directions of the first and second display screens 22 and 23 depending on the rotation angle of the large-sized display 21. Therefore, in this embodiment, the rotation disk 43 of the display rotation mechanism 40 is disposed with a rotation angle detecting portion 64.

Although various means of detecting the rotation direction and the rotation angle of the rotation disk 43 have conventionally been proposed and these known technologies may be applied to the embodiment, the simplest configuration may be configured by arranging limit switches 64a, 64b, and 64c (see FIGS. 6 and 7) on the bottom surfaces of the respective pin grooves 43a, 43b, and 43c such that the corresponding limit switch is turned on when the leading end of the rotation fixing pin 46 engages with any one of the pin grooves.

Since the device control portion 59 is sensible of the rotation direction and the rotation angle of the large-sized display 21 by inputting the on/off signals of the limit switches 64a, 64b, and 64c into the device control portion 59, the display directions of the first and second display screens 22 and 23 of the large-sized display 21 may be switched based on these signals. Therefore, various disposition forms may be achieved in accordance with circumstances of stores.

According to the present invention, the following effect may be acquired.

The present invention may provide a display-integrated image forming apparatus requiring no large disposition location and an extremely simple disposition operation and capable of acquiring sufficient advertising effects for pedestrians on sidewalks.

1. A display-integrated image forming apparatus comprising:
an image forming device including a document reading portion that reads an image of an document, a first operating portion that accepts operational input, a printing portion that performs a printing operation in accordance with an operation to the first operating portion, and a control portion that controls the above portions; and
a displaying device being disposed on at least one side surface of the image forming device, the displaying device including a first display screen viewable from the backside or the side of the image forming device, the display-integrated image forming apparatus displaying various pieces of provision information to be provided to users on the first display screen through the control portion of the image forming device,
the display-integrated image forming apparatus comprising a second operating portion that accepts operational input to the first display screen, the display-integrated image forming apparatus displaying information related to printing of selected provision information on the first display screen if the provision information displayed on the first display screen is selected through an operation to the second operating portion.

2. The display-integrated image forming apparatus as defined in claim 1, wherein
the image forming device includes a storage portion that stores information, and wherein the control portion stores the information related to printing of the selected provision information into the storage portion.

3. The display-integrated image forming apparatus as defined in claim 2, wherein
if the information related to printing of the provision information displayed on the first display screen is input to the first operating portion, the printing portion prints information preliminarily correlated with the selected provision information.

4. The display-integrated image forming apparatus as defined in claim 2, wherein
if the information related to printing of the provision information displayed on the first display screen is input to the first operating portion, the control portion clears the information related to printing of the provision information displayed on the first display screen.

5. The display-integrated image forming apparatus as defined in claim 2, wherein
if a predetermine time elapses without the information related to printing of the provision information being input to the first operating portion after the information related to printing of the provision information is displayed on the first display screen, the control portion clears the information related to printing of the provision information displayed on the first display screen.

6. The display-integrated image forming apparatus as defined in claim 5, wherein
if a predetermine time elapses without the information related to printing of the provision information displayed on the first display screen being input to the first operating portion after the information related to printing of the provision information displayed on the first display screen is cleared, the information related to printing of the provision information displayed on the first display screen is cleared from the storage portion.

7. The display-integrated image forming apparatus as defined in claim 2, comprising a second display screen viewable from an operator of the image forming device, wherein
the second display screen is disposed to project upward from the image forming device.

8. The display-integrated image forming apparatus as defined in claim 7, comprising a third operating portion that accepts operational input to the second display screen, wherein
if the information related to printing of the provision information displayed on the first display screen is input to either the first operating portion or the third operating portion, the printing portion prints information preliminarily correlated with the selected provision information.

9. The display-integrated image forming apparatus as defined in claim 7, wherein
if the information related to printing of the provision information displayed on the first display screen is input to either the first operating portion or the third operating portion, the control portion clears the information related to printing of the provision information displayed on the first display screen.

10. The display-integrated image forming apparatus as defined in claim 7, wherein
if a predetermine time elapses without the information related to printing of the provision information displayed on the first display screen being input to either the first operating portion or the third operating portion, the control portion clears the information related to printing of the provision information displayed on the first display screen.

11. The display-integrated image forming apparatus as defined in claim 10, wherein
if a predetermine time elapses without the information related to printing of the provision information displayed on the first display screen being input to either the first operating portion or the third operating portion after clearing the display of the information related to printing of the provision information displayed on the first display screen, the control portion clears from the storage portion the information related to printing of the provision information displayed on the first display screen.

12. The display-integrated image forming apparatus as defined in claim 3, wherein
in response to the completion of printing of the selected information by the printing portion, the control portion clears from the storage portion the information related to printing of the provision information displayed on the first display screen.
